(19) United States
(12) Patent Application Publication
(10) Pub. No.: US 2015/0097065 A1
(43) Pub. Date: Apr. 9, 2015

(54) COILED ROD REEL

(71) Applicant: C-Tech Oil Well Technologies Inc., Edmonton (CA)

(72) Inventors: Alex Perri, Edmonton (CA); Dean Passey, Edmonton (CA); Harvey Verstraete, Edmonton (CA); Randy Bourne, Red Deer (CA)

(73) Assignee: C-Tech Oil Well Technologies Inc., Edmonton (CA)

(21) Appl. No.: 14/242,675

(22) Filed: Apr. 1, 2014

Related U.S. Application Data
(60) Provisional application No. 61/886,185, filed on Oct. 3, 2013.

(51) Int. Cl. B65H 75/08; B65H 75/20; F16B 2/02

(52) U.S. Cl. CPC B65H 75/08; F16B 2/02; B65H 75/20
USPC 242/118.1

(57) ABSTRACT

A reel for transporting continuous rod with a clamping system to hold the rod against excess, unsafe movement of the rod during the loading and unloading of the rod onto the reel. The clamping system has a rod end clamp and a guide that can move with the rod or move the rod into a preferred position.

### TECHNICAL FIELD

Reels for continuous rods.

### BACKGROUND

This invention relates to transport and service reels for continuous rods. The typical means of preparing a rod for storage or transport is to coil it around large circular spools or reels. As rods are generally stiff lengths of hard and solid metal, looping them in a circular manner is difficult, as there are high amounts of tension and stress at the ends of the rod as it is being reeled. This can also result in a certain amount of danger for workers; improper attachment of the end of the rod to the reel while spooling can result in the rod detaching from the reel at the rod end and returning to an uncoiled state at an extremely high rate of speed.

This danger may be enhanced by an inability to moderate the amount of stress the clamping device at the end of the rod is under during the spooling. During the initial loading of reels and the final unloading process, the rod may change position and put varying amounts of forces on the rod end clamp, again putting undue strain on the single point of connection at the rod end. This potential excess movement can therefore also be a hazard to surrounding workers. Wires have been used to secure the rod end, but the use of wire results in potential hazard to operators and may create pinch points.

### SUMMARY

According to an aspect of the invention, there is provided a reel for holding continuous rod, the reel comprising a cage and a clamping system for securing rod, the clamping system being secured to the cage.

A method is also disclosed of securing continuous rod onto a reel comprising a cage, the method comprising: conveying the rod over a first ring disposed about the cage; and securing the rod end with a rod end clamp to the cage

In various embodiments there may be included any one or more of the following features: The cage has radially extending arms and the clamping system comprises a rod end clamp secured to the cage at an outermost point of one of the radially extending arms. The cage has a periphery and the clamping system comprises a rod end clamp secured to the cage at the periphery. The rod end clamp comprises a rod receiving part and a clamping portion. The rod receiving part comprises a funnel. The clamping portion comprises: arms pivotally connected at a pivot axis, the arms extended away from the pivot axis towards respective ends of the arms to form a rod clamping space between the arms; and a tightener secured to the arms for tightening the clamping portion against the rod. The rod clamping space is between the pivot axis and the tightener. The tightener comprises a threaded bolt, the threaded bolt extended through respective holes in each arm. The rod end clamp is pivotally mounted to the cage by a pivot. The pivot has at least a pair of pivot axes at right angles to each other. The pivot has a ball joint connection that provides the pair of pivot axes. The reel is a transport reel, and the cage comprises a central ring, and the clamping system further comprises a frame secured to the cage, a guide forming part of the frame and a rod retainer mounted on the guide and the guide being movable to and away from the central ring of the cage. The guide comprises a rod guide mounted for linear movement along a swing arm. The frame comprises parallel guide columns and a shaft connected between the parallel guide columns, the swing arm being connected to the shaft. The rod guide is pivotally mounted on the swing arm. The rod guide is pivotally mounted for rotation about two or more perpendicular axes. Holding the rod with a guide spaced circumferentially around the cage from the rod end clamp. The rod is moved into a preferred position by the guide. The guide holds the rod when the rod end clamp is not engaged. Detaching the guide from the rod when the rod is in a stress free position.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 illustrates a portion of a transport reel showing an embodiment of a rod end clamp and a guide assembly with a horizontal shaft.

FIG. 2 is a view of the guide assembly of FIG. 1.

FIG. 3 shows the C-shaped rod guide of FIG. 1 in the open position.

FIG. 4 shows an alternative view of the clamping system of FIG. 1 with a rod pin end coupler.

FIG. 5 shows an embodiment of a rod end clamp with a rod pin end coupler.

FIG. 6 is an embodiment of a clamping system where the guide assembly has a rotating horizontal shaft.

FIG. 7 shows an alternative view of the rod end clamp of FIG. 5

FIG. 8 shows the embodiment of a rod end clamp of FIG. 5.

FIG. 9 shows the clamping system of FIG. 6 when the reel has one wrap of rod and the guide is in the lower position, and with a rod pin end coupler.

FIG. 10 shows an alternative view of the embodiment of FIG. 9.

FIG. 11 shows the guide body of FIG. 6.

FIG. 12 shows an alternative view of the guide body of FIG. 11 without the rod engaged.

FIG. 13 shows the guide body of FIG. 11 where the C-shaped rod guide is open.

FIG. 14 shows the guide body of FIG. 11 where the C-shaped rod guide is closed.

FIG. 15 shows the C-shaped rod guide assembly of FIG. 6.

FIG. 16 shows an alternative view of the C-shaped rod guide assembly of FIG. 12 where the C-shaped rod guide is closed.

FIG. 17 shows an alternative view of the rod guide assembly of FIG. 6 where the C-shaped rod clamp is open.

FIG. 18 shows a side view of an embodiment of a clamping system.

FIG. 19 shows an embodiment of a service reel frame.

FIG. 20 shows an embodiment of an arm of a service reel frame with a rod end clamp attached.

FIG. 21 shows an alternative view of the embodiment of FIG. 12.

FIG. 22 shows the guide body of FIG. 11 where the C-shaped rod guide is open.

### DETAILED DESCRIPTION

Immaterial modifications may be made to the embodiments described here without departing from what is covered by the claims.

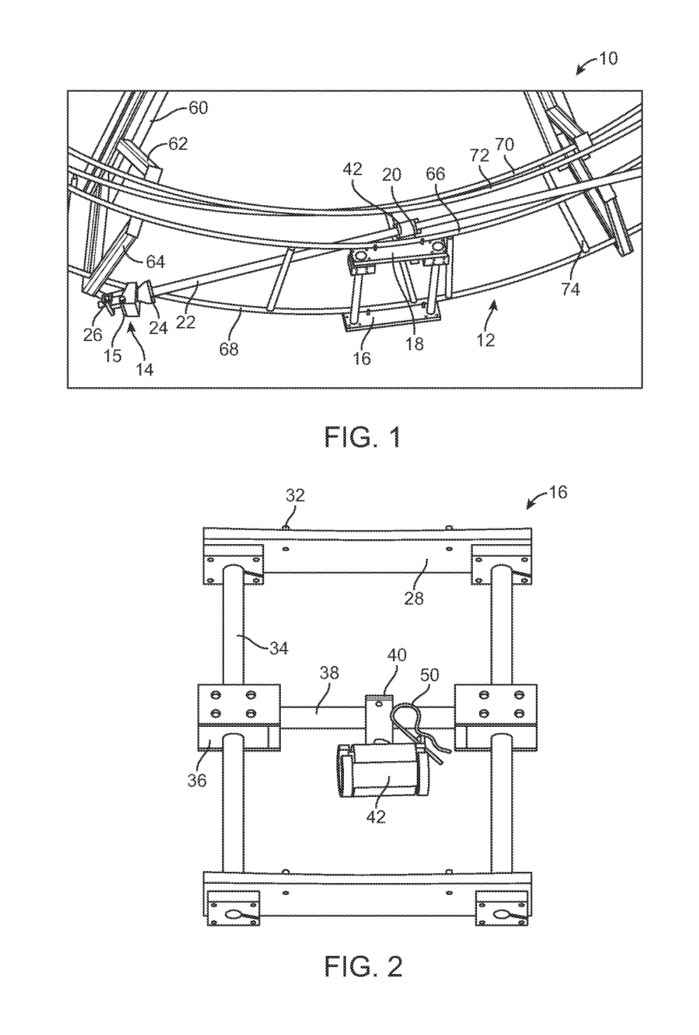

Referring to FIG. 1, a portion of a reel 10 for transporting continuous rod is shown. The reel has a cage 12 and a clamping system secured to the cage 12. The cage 12 has rings 66, 68, 70 and 72 extending circumferentially around the cage, intermediate ring supports 74 extending between rings, and a frame with a base 60, inner ring supports 62 and outer ring supports 64. The outer ring support 64 supports an outer upper ring 66, central ring 68 and lower ring 70 and the inner ring support 62 supports an inner upper ring 72. The clamping system preferably comprises a rod end clamp 14 and a guide assembly for example, a guide body 16. The guide body is preferably spaced circumferentially around the cage from the rod end clamp 14 and includes a guide frame 18 and a guide 20 forming part of the frame. The guide 20 has a C-shaped rod guide 42 that loosely clamps around the rod 22 and may move with the rod as the rod changes position during the initial loading of rod onto reels and the final reel unloading processes. When the rod end clamp 14 is not engaged the guide assembly 16 will control excess, unsafe movement of the rod until the rod is in a stress free position. At that point, the guide may be detached from the rod. Although a specific design of reel is shown, the disclosed clamping system may be used with any reel design for holding coiled rod that requires clamping of a rod in a reel. In reel designs where there is one or more central rings or like element or elements, the clamp 14 may be located on or near the central ring(s) or element(s).

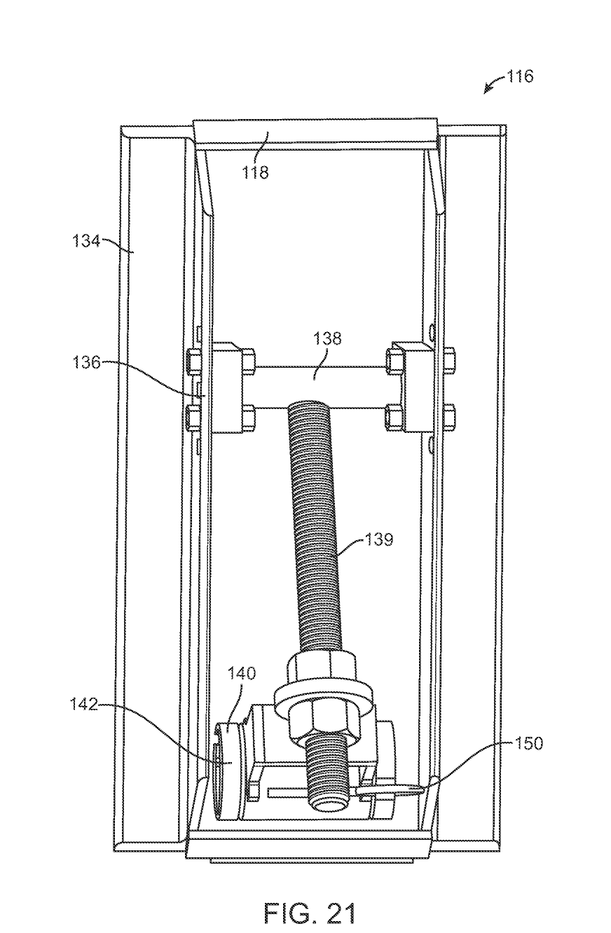

Referring to FIG. 2, the guide 16 may be for example a self-contained assembly that is welded into place or attached by any other suitable means to the cage 12, as for example to the outer upper ring 66 and the central ring 68 on the transport reel. The guide 16 may be located outside of the volume defined by the elements of the cage 12, as for example, outside the rings 66 and 68. The guide 16 may comprise a frame, for example, two plates 28 with flange mounted shaft supports 30 and a pair of alignment dowels 32. The shaft supports are clamped to two parallel guide columns 34 with pillow-block linear sleeve bearings on each. These sleeve bearings have U-shaped shaft support frames 36 which bolt around them, supporting a horizontal shaft 38. The horizontal shaft 38 is allowed to float to accommodate any slight out of parallel condition in the vertical guide columns 34. On the horizontal shaft, there is mounted a C-shaped rod guide assembly 40. The assembly 40 has a degree of travel along the shaft suited to the size of the cage, for example, 6¾ inches for a conventional size of reel. In another embodiment shown in FIG. 6 and described below for example with respect to FIG. 21, the frame has an adjustable swing shaft 38, and supports 30 allow the shaft 38 to pivot. The C-shaped rode guide 20 may be mounted on the shaft 38 and is allowed to rotate on the swing shaft 38 to accommodate the angle of the rod 22.

Referring to FIG. 2, the two vertical guide columns 34 are for example hardened shafts with a machinable end. The bottom ends of these shafts may be machined down and the bottom flange mounted shaft supports have shaft holes to accommodate them. This arrangement ensures that the shafts cannot drop through the shaft supports should the clamping bolts come loose during transportation, though other arrangements may be used to achieve the same object, as for example pins. Dowel pins 32 in the support plates may be used to position the guide assembly 16 against the transport reel. The preferred position around the circumference of the reel is a matter of design choice, for example 20 to 30 degrees from the clamp 14. An example is shown in FIG. 1.

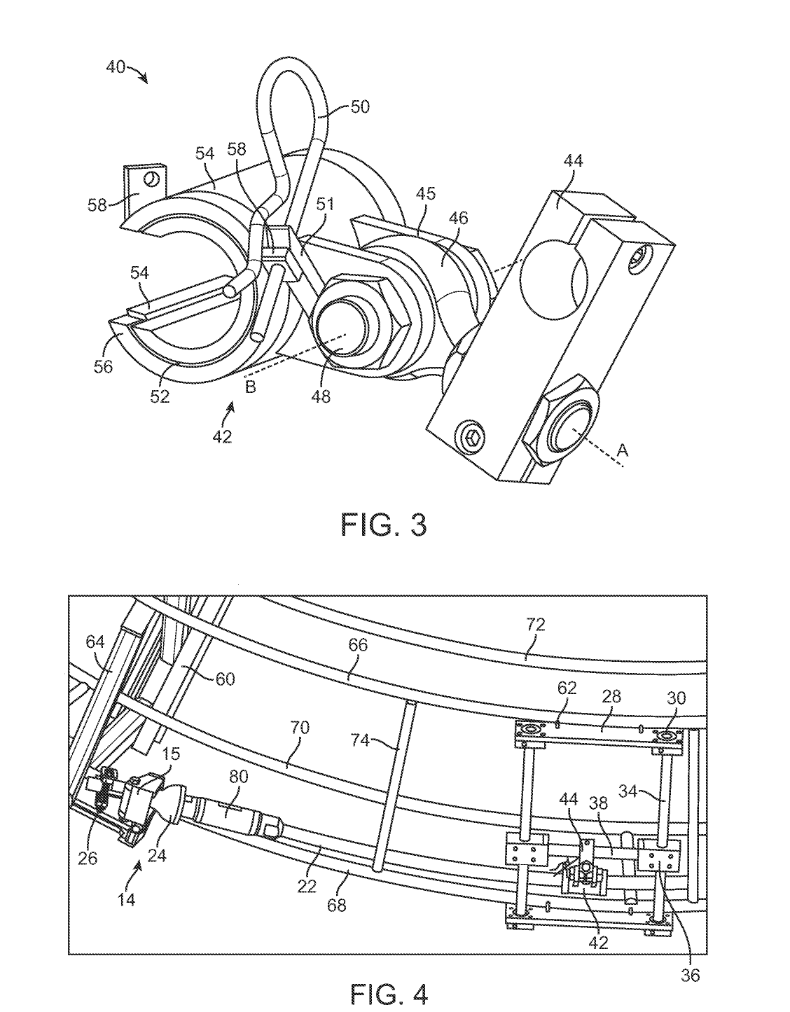

Referring to FIG. 3, the rod guide assembly 40 is shown with a C-shaped rod clamp 42. The rod guide assembly 40 may have a pivoting plate 44 to allow the assembly 40 to rotate on the shaft 38. Plate 44 may have a ball joint type rod end 46 that can pivot within the guide block. In embodiments such as those shown in FIG. 6 the plate 44 may have a mechanism such as swing arm 139 for adjusting the extension of the C-shaped clamp 42. Referring to FIG. 3, a bolt 48 is fitted through the ball joint and on it pivots a rod clamp support 45 attached to the c-shaped rod clamp 42. The rod guide assembly 40 may allow the c-shaped rod clamp 42 to pivot at two pivot axes A and B, as shown in FIG. 3. Pivot axes A and B may be perpendicular or at right angles to each other. In some embodiments, the pivoting of the ball joint rod end within the guide block at pivot axis A may be eliminated.

The c-shaped rod clamp 42 is kept in the open or closed position with a hairpin type retainer 50. The hairpin type retainer may be kept on a lanyard. Various types of retainer may be used depending on the clamp design.

C-shaped rod clamp 42 comprises a rotating cuff 52 and a fixed cuff 54 attached to the rod clamp support 45. Retainer holes 58 on the outer rim 56 of rotating cuff 52 may rotate to locking position 51 to open and close the c-shaped rod clamp 42. Various other types of retainer holes may be used depending on the clamp type.

Due to the many degrees of freedom within the C-shaped rod guide assembly and body, the guide can achieve a position of no contact with the rod, indicating a no-stress state within the rod.

During the loading and unloading processes continuous rod is secured onto a reel by the clamping system while the rod is being conveyed over a ring disposed about the cage. The rod may be held by the rod end clamp and the guide to prevent unsafe movement of the rod.

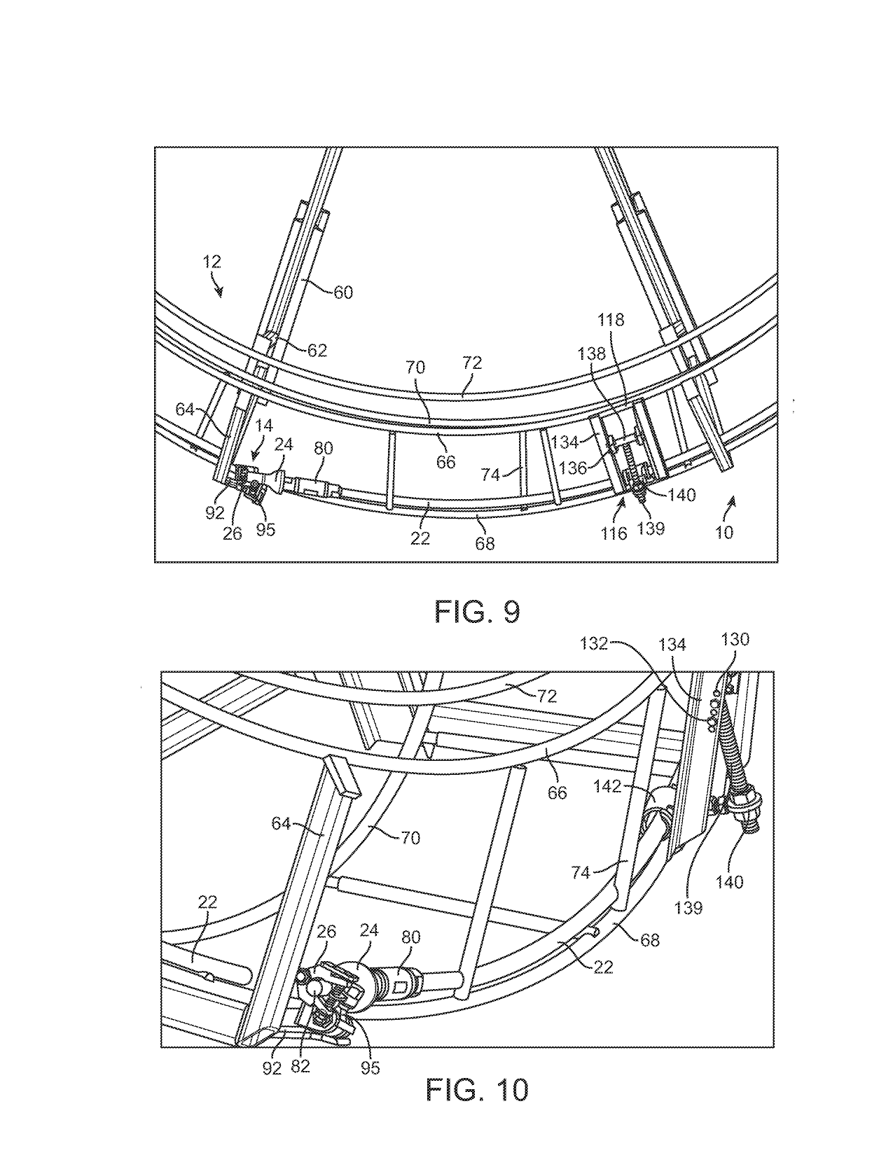

The guide 16 engaged with the rod 22 may be moved into a lower position while the rod is loaded, unloaded or stored on the rod, as shown in FIGS. 4 and 9 when the reel has one wrap of rod on it.

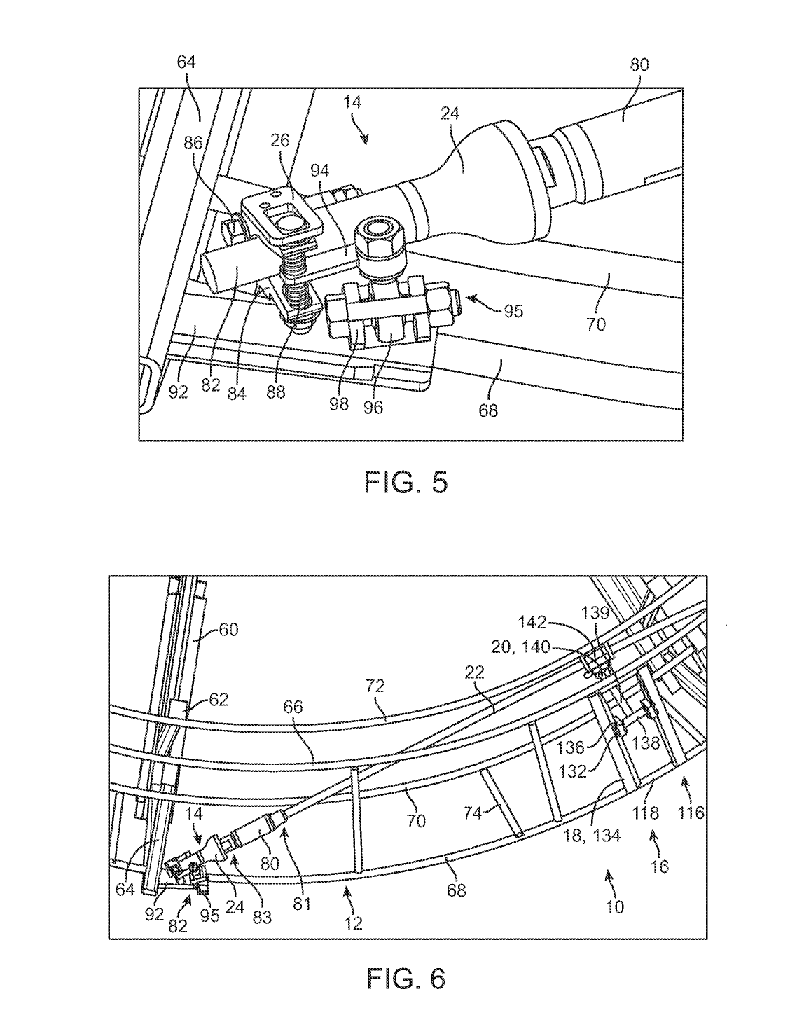

As shown in FIG. 5, the rod end clamp 14 has a rod receiving part 24, for example a funnel, and clamping portion 26. The clamping portion has a pair of complementary arms 84 that are pivotally connected at a pivot axis 86 and a tightener 88 to tighten the clamping portion 26 around the rod so that the complementary arms 84 contacting the rod at a gripping surface. Tightener 88 may be for example a threaded bolt that extends through respective holes in complementary arms 84. The rod end clamp 14 may be pivotally secured to the cage for example by pivot assembly 95 to allow the rod end clamp to move with the rod 22 as the rod changes positions during the loading and unloading processes.

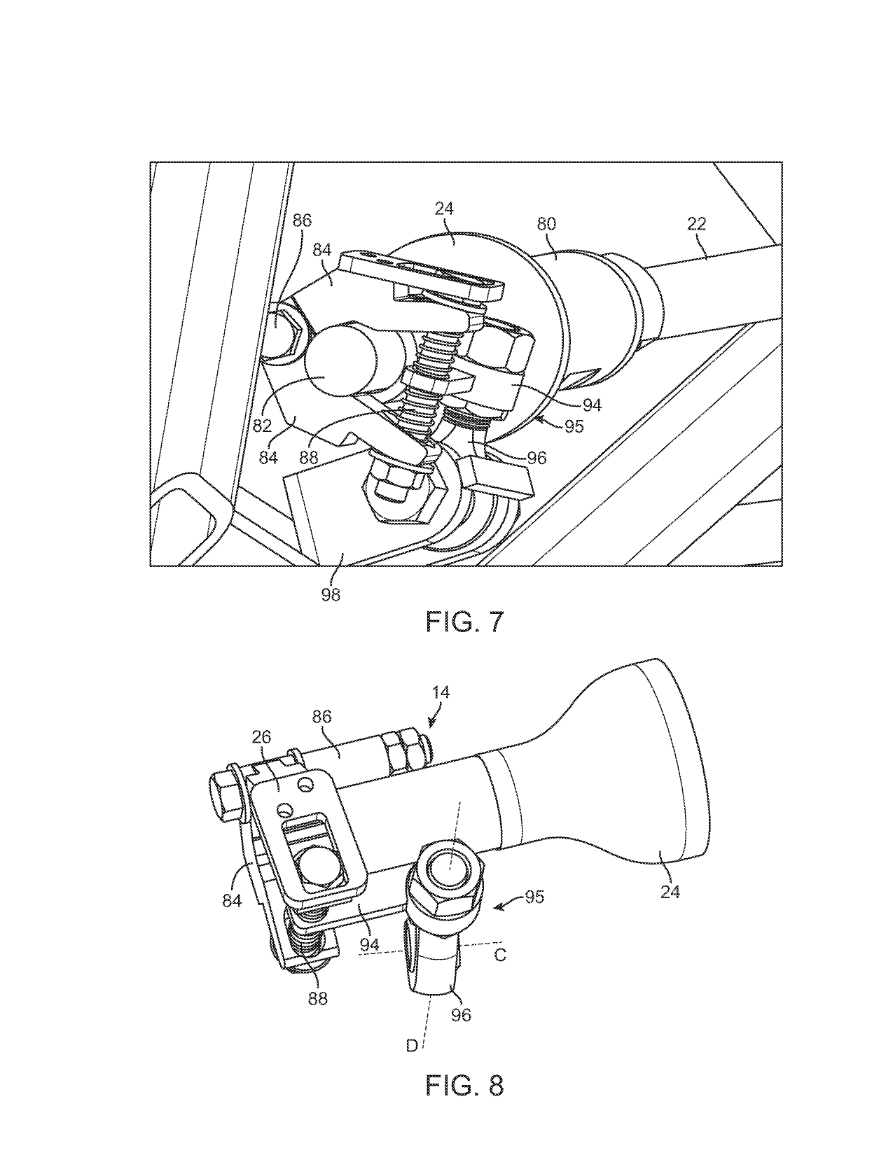

Referring to FIG. 5, rod funnel clamp 14 may be attached to the reel 10 by a pivot assembly connected to a funnel clamp support 92 on base 64. Pivot assembly 95 comprises a pivot rod 96 with a ball joint type rod end that can pivot in a support 98 of the rod funnel clamp mounting bar 92 and a threaded end threadedly engaged with funnel arm 94 attached to the funnel 24. Funnel arm 94 may engage tightener 88. As shown in FIG. 7, a bolt on the support 98 may be fitted through the ball joint.

The pivot assembly allows the rod funnel clamp 14 to pivot relative to the reel 10 at two pivot axes C and D, as shown in FIG. 8. Pivot axes C and D may be perpendicular or at right angles to each other.

The rod may be supplied as a finished length with a male threaded rod end welded onto one or both ends of the rod, for example when the exact length of the required rod is known. Referring to FIG. 6, the threaded rod end may be threadedly engaged with a first end 81 of a coupler such as a rod pin end coupler 80. A rod end 82 with a threaded end may be threadedly engaged with a second end 83 of the coupler 80. Rod end 82 may then be clamped by the rod end clamp 14, as shown in FIG. 7. The coupler 80 may have a sleeve shape as shown. Alternatively, the second end 83 of the coupler 80 may be threadedly engaged with a threaded rod end of another rod to join multiple rods together. The coupler 80 may have two female threaded ends, and the ends may be two different sized female threads, allowing different diameters of rod to be joined together.

The rod may be supplied without threaded ends, for example when the exact length is not known or multiple reels need to be joined together in the field, or when shipping the unfinished rod between the plant and the processing yards. A rod without threaded ends may be directly clamped by the rod end clamp, as shown in FIG. 18.

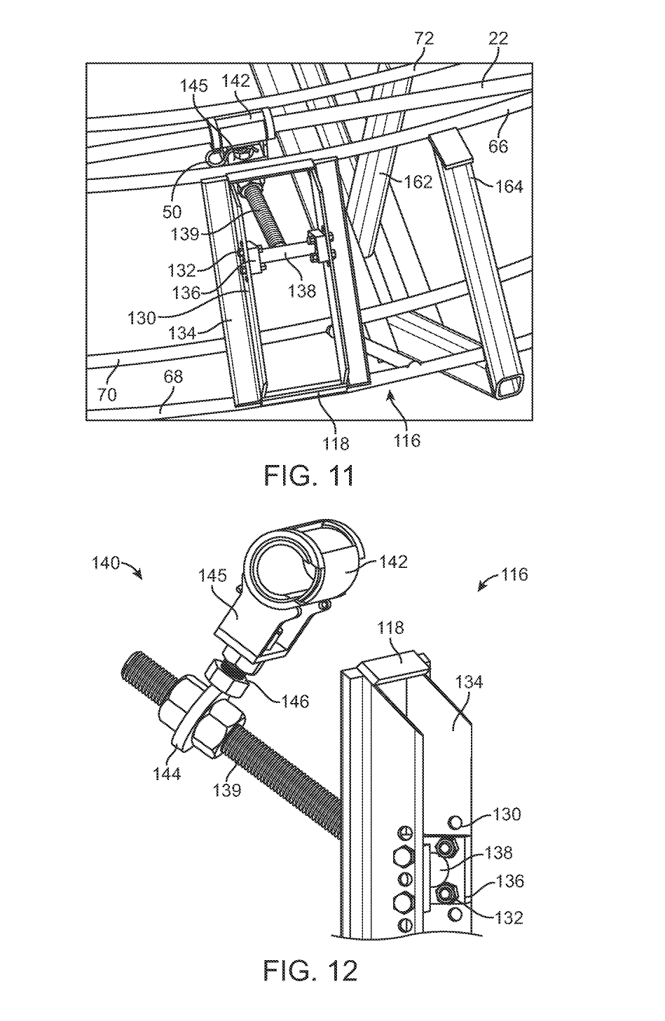

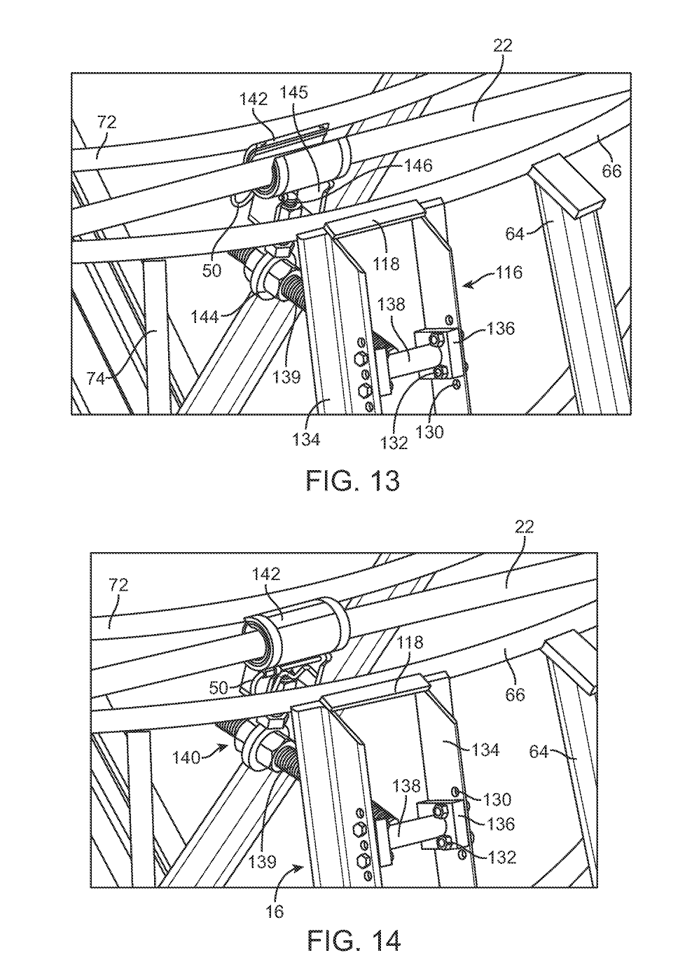

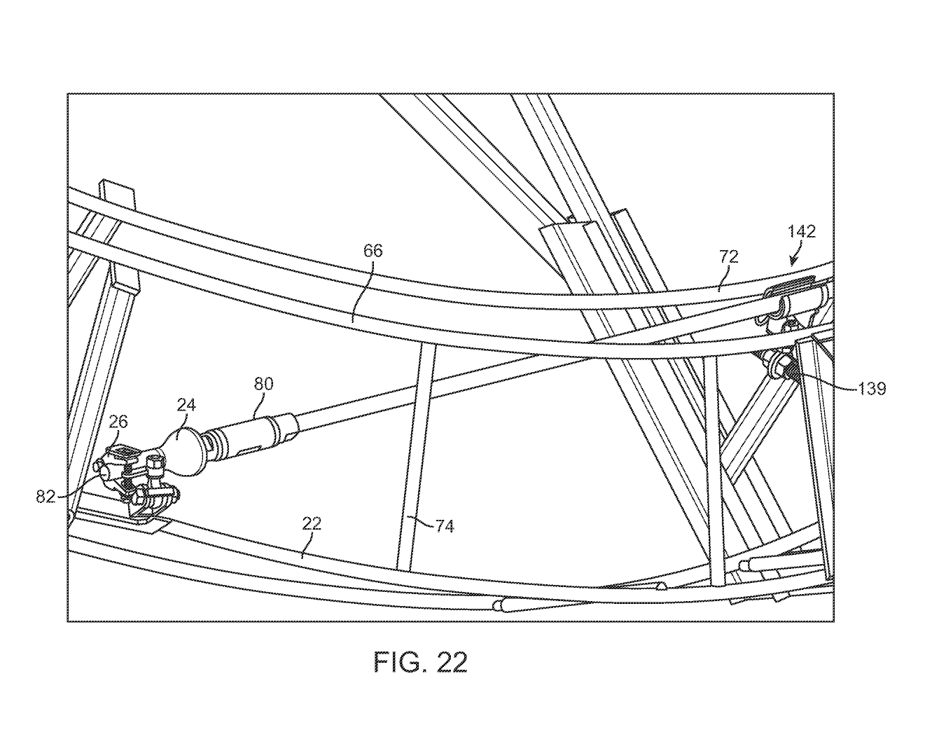

Referring to FIG. 6, the guide 116 may be for example a self-contained assembly that is welded into place or attached by any other suitable means to the cage 12, as for example to the outer upper ring 66 and the central ring 68 on the transport reel as shown. The guide 116 may be located outside of the volume defined by the elements of the cage 12, as for example outside the rings 66 and 68. Referring to FIG. 11, the guide 116 may comprise two parallel guide columns 134 and horizontal supports 118. Shaft support frames or plates 136 supporting a horizontal shaft 138 may be fixed, for example for relative sliding movement, to the parallel guide columns 134 for example by bolts 132 extending through holes 130 in parallel guide columns 134. Horizontal shaft 138 may be allowed to rotate or swing arm 39 may be allowed to rotate about shaft 138. As shown in FIG. 12, parallel guide columns 134 may have multiple holes 130 to receive bolts 132 so that the horizontal shaft 138 may be fixed at multiple positions between outer upper ring 66 and central ring 68. A swing arm 139 may extend perpendicularly from horizontal shaft 138 and support a rod guide assembly 140. FIGS. 13 and 22 show the rod end clamp 14 engaged and the guide 116 ready to be attached to rod 22 at top position. The rod clamp may then be closed around the rod as shown in FIG. 14.

The guide 116, engaged with the rod 22, may be moved into a lower position while the rod is loaded, unloaded or stored on the rod, as shown in FIGS. 9 and 10 when the reel has one wrap of rod on it. If the rod 22 is in a stress-free position, the C-shaped rod guide 42 may then be opened, and retracted and removed from the rod.

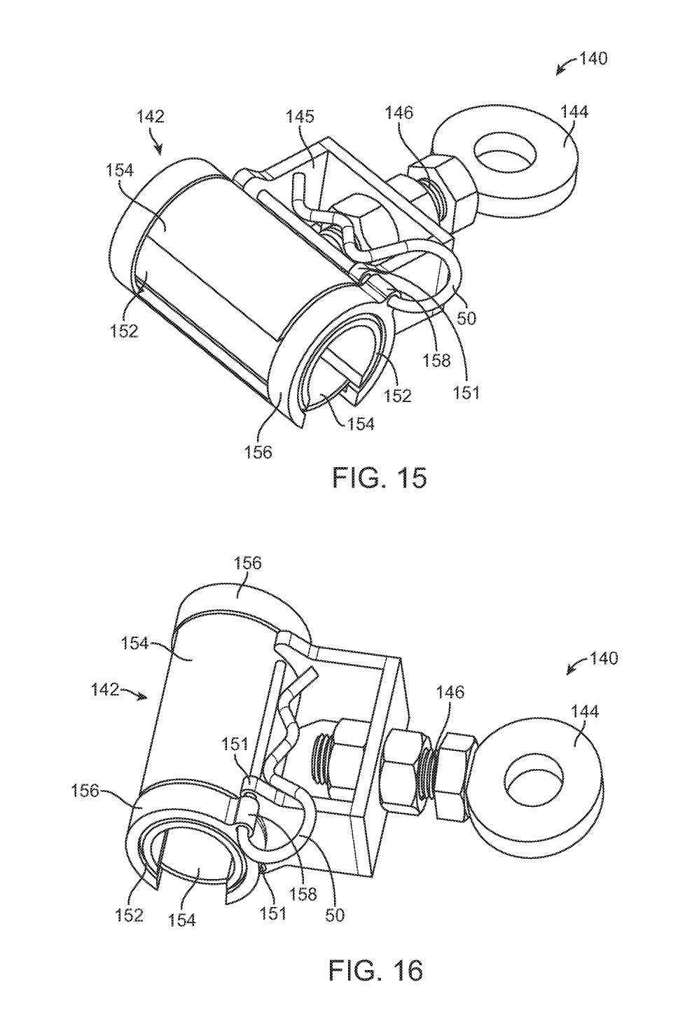

Referring to FIG. 15, the rod guide assembly 140 may be pivotally mounted on the swing arm 139. The rod guide assembly 140 may have a pin bolt 144 with a first end that is fitted onto the swing arm 139 and a second threaded end 146 that is fitted through a rod clamp support 145 attached to a C-shaped rod guide 142. The rod guide 142 is kept in the open or closed potion with a hairpin type retainer 50.

Rod guide 142 comprises a rotating cuff 152 and a fixed cuff 154 attached to the rod clamp support 145. Retainer hole 158 on the outer rim 156 of rotating cuff 152 may rotate between locking positions 151 to open and close the rod guide 142.

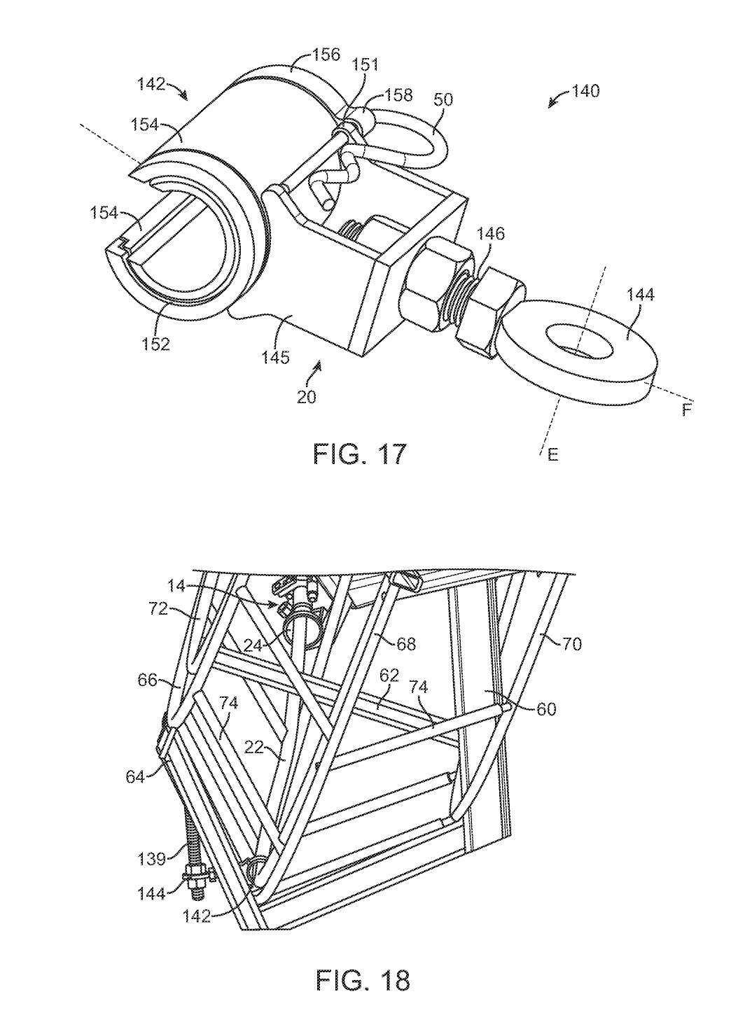

FIG. 17 shows the rod guide 142 in the open position with a hairpin type retainer 50 at a first locking position. The rotating cuff may slide relative to the fixed cuff to close the rod guide 142, as shown in FIG. 16.

The rod guide assembly 140 may allow the rod clamp 142 to pivot at two or more pivot axes E and F, as shown in FIG. 17. Pivot axes E and F may be perpendicular or at right angles to each other. In some embodiments, the pivoting of the rod guide carriage or assembly 140 on the swing arm 139 at pivot axis E and of the rod clamp support 145 on the pin bolt 144 at pivot axis F may be eliminated.

The guide 16 may be used to prevent excess movement of the rod 22 during the loading and unloading of the rod onto the reel. The guide 16 may be used to move the rod into a preferred position within the reel for the loading or unloading processes, for example, to center the rod on the reel.

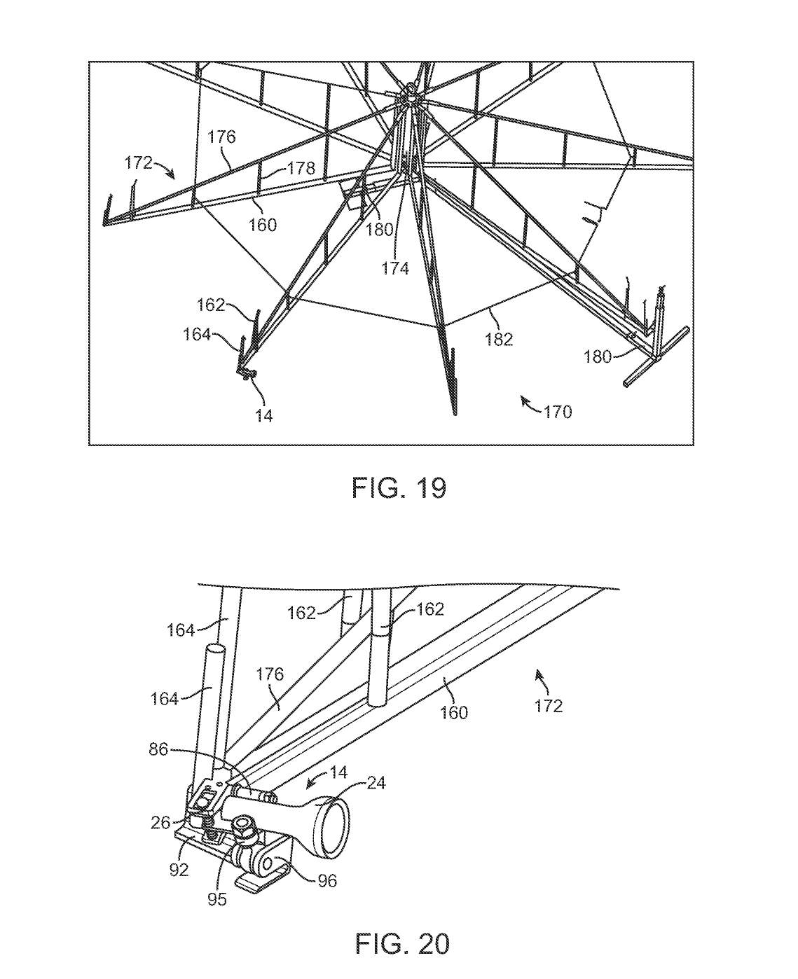

Referring to FIG. 19, the frame 170 of the service reel has radially extending arms 172, with an upper bar 176, a lower bar 160 and arm supports 178, disposed around a center member 174. Inner ring supports 162 and outer ring supports 164 at the ends of arms 172 support removable rings. A rod end funnel clamp may be attached to the end of an arm as shown in FIG. 20.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A reel for holding continuous rod, the reel comprising:
a cage; and
a clamping system for securing rod, the clamping system being secured to the cage.

2. The reel of claim 1 in which the cage has radially extending arms and the clamping system comprises a rod end clamp secured to the cage at an outermost point of one of the radially extending arms.

3. The reel of claim 1 in which the cage has a periphery and the clamping system comprises a rod end clamp secured to the cage at the periphery.

4. The reel of claim 2 in which the rod end clamp comprises a rod receiving part and a clamping portion.

5. The reel of claim 4 in which the rod receiving part comprises a funnel.

6. The reel of claim 4 in which the clamping portion comprises:
arms pivotally connected at a pivot axis, the arms extended away from the pivot axis towards respective ends of the arms to form a rod clamping space between the arms; and
a tightener secured to the arms for tightening the clamping portion against the rod.

7. The reel of claim 6 in which the rod clamping space is between the pivot axis and the tightener.

8. The reel of claim 7 in which the tightener comprises a threaded bolt, the threaded bolt extended through respective holes in each arm.

9. The reel of claim 2 in which the rod end clamp is pivotally mounted to the cage by a pivot.

10. The reel of claim 9 in which the pivot has at least a pair of pivot axes at right angles to each other.

11. The reel of claim 10 in which the pivot has a ball joint connection that provides the pair of pivot axes.

12. The reel of claim 1 in which the reel is a transport reel, and the cage comprises a central ring, and the clamping system further comprises a frame secured to the cage, a guide forming part of the frame and a rod retainer mounted on the guide and the guide being movable to and away from the central ring of the cage.

13. The reel of claim 12 in which the guide comprises a rod guide mounted for linear movement along a swing arm.

14. The reel of claim 13 in which the frame comprises parallel guide columns and a shaft connected between the parallel guide columns, the swing arm being connected to the shaft.

15. The reel of claim 13 in which the rod guide is pivotally mounted on the swing arm.

16. The reel of claim 15 in which the rod guide is pivotally mounted for rotation about two or more perpendicular axes.

17. A method of securing continuous rod onto a reel comprising a cage, the method comprising:
conveying the rod over a first ring disposed about the cage; and
securing a rod end with a rod end clamp to the cage.

18. The method of claim 17 further comprising holding the rod with a guide spaced circumferentially around the cage from the rod end clamp.

19. The method of claim 18 in which the rod is moved into a preferred position by the guide.

20. The method of claim 19 in which the guide holds the rod when the rod end clamp is not engaged.

21. The method of claim 17 further comprising detaching the guide from the rod when the rod is in a stress free position.
